(19) United States
(12) Patent Application Publication
(10) Pub. No.: US 2023/0217333 A1
(43) Pub. Date: Jul. 6, 2023

(54) IMPROVED HANDLING TEMPORARILY UNREACHABLE ZONES IN A WIRELESS COMMUNICATION NETWORK

(71) Applicant: Telefonaktiebolaget LM Ericsson (publ), Stockholm (SE)

(72) Inventors: Behrooz MAKKI, Pixbo (SE); Mikael COLDREY, Borås (SE); Jingya LI, Göteborg (SE)

(73) Assignee: Telefonaktiebolaget LM Ericsson (publ), Stockholm (SE)

(21) Appl. No.: 17/927,256

(22) PCT Filed: May 28, 2020
(86) PCT No.: PCT/EP2020/064880

§ 371 Date: Nov. 22, 2022

(51) Int. Cl. H04W 36/08; H04W 36/02; H04W 36/00; H04W 36/32

(52) U.S. Cl. CPC H04W 36/08; H04W 36/02; H04W 36/0058; H04W 36/32

(57) ABSTRACT

The present disclosure relates to a serving wireless communication node (AP₁) in a wireless communication system (1), wherein the serving node (AP₁) is adapted to determine that a served user terminal (2) is going to enter a zone (3) that switches between being reachable and unreachable for the serving node (AP₁), and to predict data (xₘ₊₁ . . . xₙ) to be transmitted to the user terminal (2) for at least a part of the time the user terminal (2) is in the zone (3) and is unreachable for the serving node (AP₁₎. When the zone (3) is reachable, the sewing node (AP₁) is adapted to transfer predicted data (xₘ₊₁ . . . xₙ) to a cache node (AP_{C}) positioned within the zone (3), enabling the cache node (AP_{C}) to transfer the predicted data (xₘ₊₁ . . . xₙ) to the user terminal (3) when the user terminal (2) is in the zone (3) and is unreachable for the serving node (AP₁).

### TECHNICAL FIELD

The present disclosure relates to maintaining service to a user terminal in a wireless communication network, even when the user terminal enters a zone that switches between being reachable and unreachable for a serving node.

### BACKGROUND

The fifth generation of wireless networks (5G) must provide high-rate data streams for everyone everywhere at any time. To meet such demands, it is required to use large bandwidths. Here, it is mainly concentrated on millimeter wave-based, potentially, massive multiple-input and multiple-output (MMIMO), links as a key enabler to obtain sufficiently large bandwidths/data rates. Importantly, the presence of very wide bandwidths makes it possible to include the wireless backhaul transport in the same spectrum as the wireless access. In such a setup, there is thus a sharing of radio resources between access and backhaul links which implies that access and backhaul links compete over the same radio resources pool.

For this reason, 3GPP has considered such integrated access and backhaul (IAB) network configurations where an access point (AP), that for example can be fiber-connected, provides other APs as well as the customer-premises equipment (CPE:s) inside its cell area with wireless backhaul and access connections, respectively. The access-integrated backhaul link can either be a single-hop or multi-hop link in an IAB network. In a multi-hop deployment, the IAB network from one AP is relayed along a certain route from AP to AP until it reaches its destination. IAB networks can thus have either star-like configuration with multiple APs wirelessly backhauled through direct single-hop connections to the fiber-connected AP, or a cascade configuration with APs wirelessly connected to the fiber-connected AP in a multi-hop fashion.

Today, a large part of world's mobile traffic comprises video where one key point in video communication is to avoid dis-connectivity. For instance, nobody likes to be dis-connected when he/she is watching a favorite film clip in an elevator. In other example, like a mission critical video used by a first responder for his/her rescue mission when entering a temporarily dead zone that is out-of-network coverage, or a safety-monitory video used by a medical personnel in a hospital when he or she lost the network connection when entering an elevator, the service disconnection can results in the loss of lives. Therefore, it is desired to enhance the wireless systems to be able to maintain a continuous video stream in temporarily dead zones. Consider a temporal dead zone as a region that can be reached by an access point (AP) only for limited periods, such as for example an elevator which can be reached by the AP when the door is open and not be reached by the AP when the door is closed. In such places, temporal dis-connectivity may occur which results in low quality-of-service for user terminals.

It is therefore desired to provide improved data coverage for temporarily unreachable zones in a wireless communication network.

### SUMMARY

It is an object of the present disclosure to provide improved data coverage for temporarily unreachable zones in a wireless communication network.

This object is obtained by means of a serving wireless communication node in a wireless communication system, where the serving node is adapted to determine that a served user terminal is going to enter a zone that switches between being reachable and unreachable for the serving node. The serving node is further adapted to predict data to be transmitted to the user terminal for at least a part of the time the user terminal is in the zone and is unreachable for the serving node.

When the zone is reachable, the serving node is adapted to transfer predicted data to a cache node positioned within the zone, enabling the cache node to transfer the predicted data to the user terminal when the user terminal is in the zone and is unreachable for the serving node.

This enables to user terminal to be continuously served with data even when it is unreachable for the serving node. This confers reliability and uninterrupted data streaming. This means that continuous communication maintained, or at least a period of disconnection is reduced, in temporal unreachable zones such as elevators. Furthermore, the end-to-end transmission delay of long files is reduced. This leads to better quality-of-service for the user terminal as well as high end-to-end throughput. If the unreachable zone has a very poor signal-to-noise ratio (SNR) and is almost a dead zone, then the network will be offloaded since the serving node does not have to allocate extensive resources to a link with very poor SNR. It also reduces the need for transport to multiple serving nodes.

According to some aspects, the serving node is adapted to initiate handover for the user terminal, from the serving node to the cache node.

This enables to cache node to take over from the serving node such that the user terminal can be continuously served with data even when it is unreachable for the serving node

According to some aspects, the serving node is adapted to determine whether to initiate the handover based on location information.

In this way, handover is initiated only when an unreachable zone is approached.

According to some aspects, the serving node is adapted to transmit a measurement configuration to the user terminal, the measurement configuration at least comprising information regarding which reference signal from the cache node to measure and on which radio resources the measurement should be performed. This enables the user terminal to transmit a measurement report to the serving node, where the serving node is adapted to determine whether to initiate the handover based on the measurement report.

In this way, a safe and controlled handover is enabled.

According to some aspects, the serving node is adapted to initiate the handover by sending a handover request to the cache node, where the handover request comprises information related to the user terminal. According to some further aspects, the information related to the user terminal comprises at least one of user terminal identification, processor capability, and number of antenna ports.

In this way, the cache node is informed about the identity and capacity of the user terminal, enabling a reliable and efficient data transfer from the cache node to the user terminal.

According to some aspects, the serving node is adapted to receive a handover acknowledgement from the cache node, to transmit a handover command to the user terminal, and then to transfer the predicted data to the cache node.

According to some aspects, the received handover acknowledgement comprises information related to the cache node.

According to some aspects, the information related to the cache node comprises at least one of cell identification and RACH (Random Access Channel) configuration of the cache node.

In this manner, the handover can be performed in a reliable and efficient manner, the serving node having all necessary information about the cache node.

According to some aspects, the serving node is adapted to inform other nodes of an adapted scheduling, where the adapted scheduling is due to the fact that the cache node is prioritized while the zone is reachable and the serving node performs handover to the cache node and transfers the predicted data to the cache node.

This means that other nodes can adapt to the present situation where the cache node is prioritized.

According to some aspects, when the zone becomes reachable for a serving node, the serving node is adapted to receive information from the cache node regarding which predicted data that has been transmitted to the user terminal when the user terminal has been unreachable for the serving node in the zone, and to perform handover for the user terminal, from the cache node to the serving node.

This means that the serving node that takes over is informed about when and where to continue the data transfer.

This object is obtained by means of a cache node in a wireless communication system, where the cache node is positioned within a zone that switches between being reachable and unreachable for a serving wireless communication node. The cache node is adapted to receive, from the serving node, predicted data to be transmitted to the user terminal for at least a part of the time the user terminal is unreachable for the serving node, and to transfer the predicted data to the user terminal when the user terminal is in the zone and is unreachable for the serving node.

This enables to user terminal to be continuously served with data even when it is unreachable for the serving node. This confers reliability and uninterrupted data streaming. This means that continuous communication maintained, or at least a period of disconnection is reduced, in temporal unreachable zones such as elevators. Furthermore, the end-to-end transmission delay of long files is reduced. This leads to better quality-of-service for the user terminal as well as high end-to-end throughput. If the unreachable zone has a very poor signal-to-noise ratio (SNR) and is almost a dead zone, then the network will be offloaded since the serving node does not have to allocate extensive resources to a link with very poor SNR. It also reduces the need for transport to multiple serving nodes.

The cache node is furthermore associated with the above advantages.

This object is also obtained by means of methods and a communication system that are associated with the above advantages.

### BRIEF DESCRIPTION OF THE DRAWINGS

The present disclosure will now be described more in detail with reference to the appended drawings, where:

FIG. 1 schematically shows a view of a wireless communication system according to a first example at a first time;

FIG. 2 schematically shows a view of a wireless communication system according to a first example at a second time;

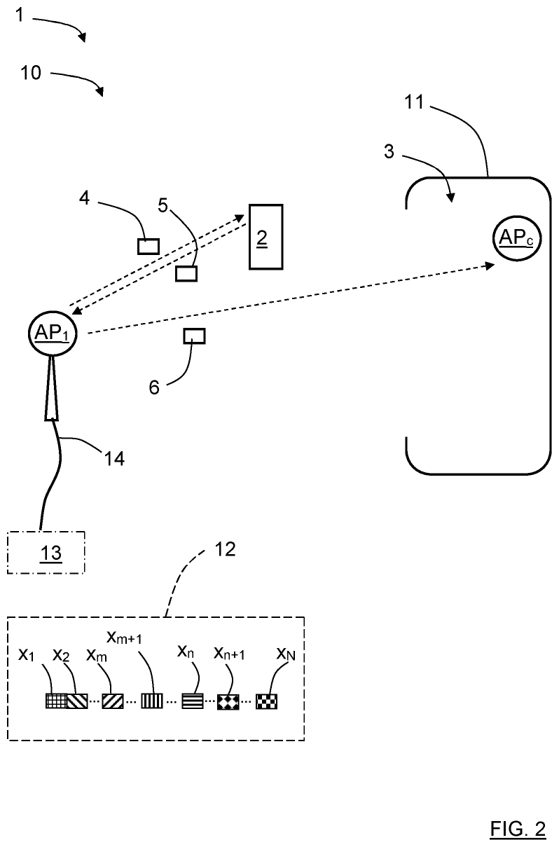

FIG. 3 schematically shows a view of a wireless communication system according to a first example at a third time;

FIG. 4 schematically shows a view of a wireless communication system according to a first example at a fourth time;

FIG. 5 schematically shows a view of a wireless communication system according to a first example at a fifth time;

FIG. 6 schematically shows a view of a wireless communication system according to a second example at the fifth time;

FIG. 7 shows a flowchart of methods according to embodiments; and

FIG. 8 shows a flowchart of methods according to embodiments.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

Network densification takes advantage of wireless backhaul; due to a relatively high installation cost of fiber links, the relatively small access points (AP:s) need to be supported by high-rate LOS wireless backhaul links which motivates so-called integrated access and backhaul (IAB) networks.

Sometimes an AP cannot reach certain zone, a temporal dead zone, is defined as a zone that switches between being reachable and unreachable for signals transmitted from the serving node, and thus constitutes a region that can be reached by an AP only for a limited time period. For such a zone it is an aim to avoid dis-connectivity or at least reduce a possible dis-connectivity period. Examples of such zones are elevators, vehicle tunnels, trains and zones having a high service demand, where the present example is directed towards an elevator.

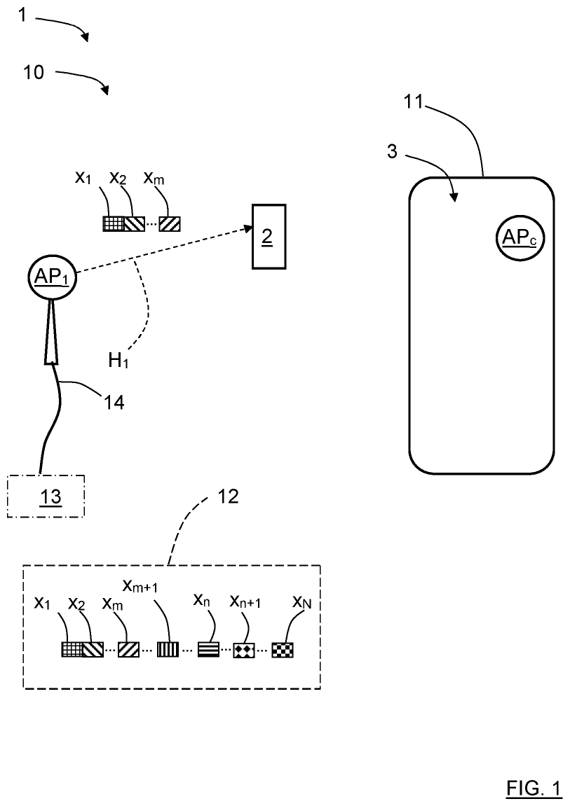

According to a first example, with reference to FIG. 1, there is a first serving communication node in the form of a first access point AP₁ in an IAB network 10 which is comprised in a wireless communication system 1. According to some aspects, the serving node AP₁ is connected to a core network 13 via a fiber connection 14 or other type of connection as indicated in FIG. 1, or, alternatively, wirelessly backhauled by other AP:s that are connected to the core network 13. The serving node AP₁ is adapted to determine that a served user terminal 2 is going to enter a zone 3 that switches between being reachable and unreachable for the serving node AP₁, here within an elevator 11. Such a user terminal 2 can for example be a mobile phone on which as user is following a streaming data flow x₁, x₂ . . . xₘ, xₘ₊₁ . . . xₙ such as a movie or a mission critical video, where a part of the streaming data flow x₁, x₂ . . . xₘ, xₘ+1 . . . x_{N} is maintained in a buffer 12 of serving node AP₁. In FIG. 1, the user terminal 2 is approaching the elevator 11 that still is closed.

The serving node AP₁ is then adapted to predict data xₘ₊₁ . . . xₙ to be transmitted to the user terminal 2 for at least a part of the time the user terminal 2 is in the zone 3 and is unreachable for the serving node AP₁. Such a prediction is alleviated for certain types of data, in particular video communication is of interest because it is pre-recorded, and is typically constituted by a long signal, but also trending tweets and breaking news constitute plausible examples. For these reasons, as opposed to the cases with interactive applications such as gaming and voice calls, it is possible to predict and plan for video communications. In other words, soon most of the data traffic will be cacheable, i.e., it is possible to store data signals which are of interest in near future at intermediate nodes to reduce the backhauling load and transmission delay.

When the elevator door opens, the zone 3 is reachable for the serving node AP₁. The serving node AP₁ is then adapted to transfer the predicted data xₘ₊₁ . . . xₙ to a cache node AP_{c} positioned within the elevator 11 and in the zone 3, where the cache node AP_{c} according to some aspects is comprised in the IAB network 10. The cache node AP_{c} can only be reached by the serving node AP₁ when the door of the elevator 11 is open. Otherwise, signaling to inside the elevator 11 is blocked, either by the door or because the elevator moves between different floors.

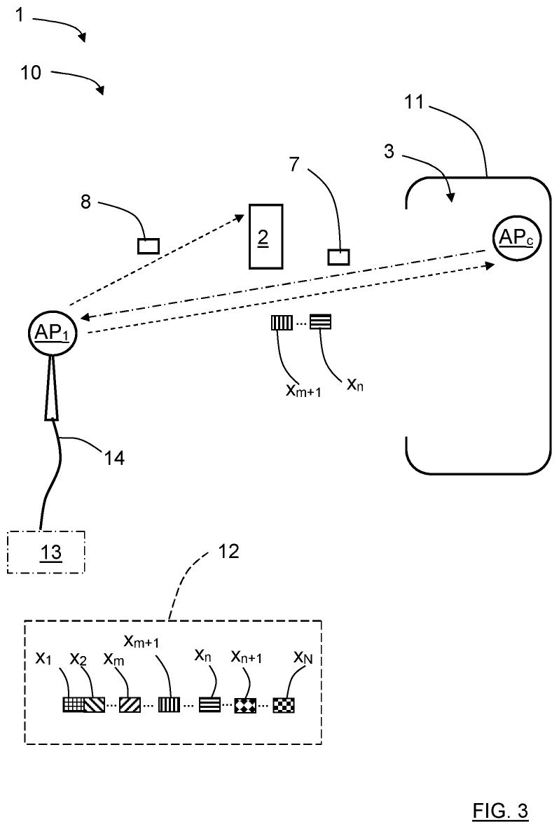

In this way, the cache node AP_{c} is enabled to transfer the predicted data xₘ₊₁ . . . xₙ to the user terminal 3 when the elevator door closes as shown in FIG. 3, the user terminal 2 then being in the zone 3 and being unreachable for the serving node AP₁.

The above can be achieved in many different ways, below an example is disclosed. It should be noted that for the different steps disclosed, many alternatives exist, and not all these steps need to be executed.

According to some aspects, in a first step, when the door of the elevator 11 opens, the cache node AP_{c} is adapted to establish a wireless connection to the serving node AP₁, for example by performing random-access procedure.

According to some aspects, in a second step, the serving node AP₁ is adapted to initiate handover for the user terminal 2, from the serving node AP₁ to the cache node AP_{c}. The serving node AP₁ may be adapted to determine whether to initiate the handover based on user terminal location information. This information can be tracked and/or predicted, and handover is initiated when the user terminal 2 is determined to be close to the elevator 11.

The serving node AP₁ is adapted to transmit a measurement configuration 4 to the user terminal 2, the measurement configuration 4 at least comprising information regarding which reference signal from the cache node AP_{c} to measure and on which radio resources the measurement should be performed, enabling the user terminal 2 to transmit a measurement report 5 to the serving node AP₁, where the serving node AP₁ is adapted to determine whether to initiate the handover based on the measurement report 5.

According to some aspects, the serving node AP₁ is adapted to initiate the handover by sending a handover request 6 to the cache node AP_{c}, where the handover request 6 comprises information related to the user terminal 2, where this information for example comprises at least one of user terminal identification, processor capability, and number of antenna ports.

According to some aspects, in a third step, the serving node AP₁ is adapted to receive a handover acknowledgement 7 from the cache node AP_{c}, to transmit a handover command 8 to the user terminal 2, and then to transfer the predicted data xₘ₊₁ . . . xₙ to the cache node AP_{c}.

According to some aspects, for example if the cache node AP_{c} is not previously known to the serving node AP₁, the received handover acknowledgement comprises information related to the cache node AP_{c}.

According to some aspects, said information comprises at least one of cell identification and information about a RACH (Random Access Channel) configuration of the cache node AP_{c}.

According to some aspects, the handover command sent to the user terminal 2 includes the information about the cache node AP_{c}, from which the user terminal 2 can access the cache node AP_{c} without reading system information.

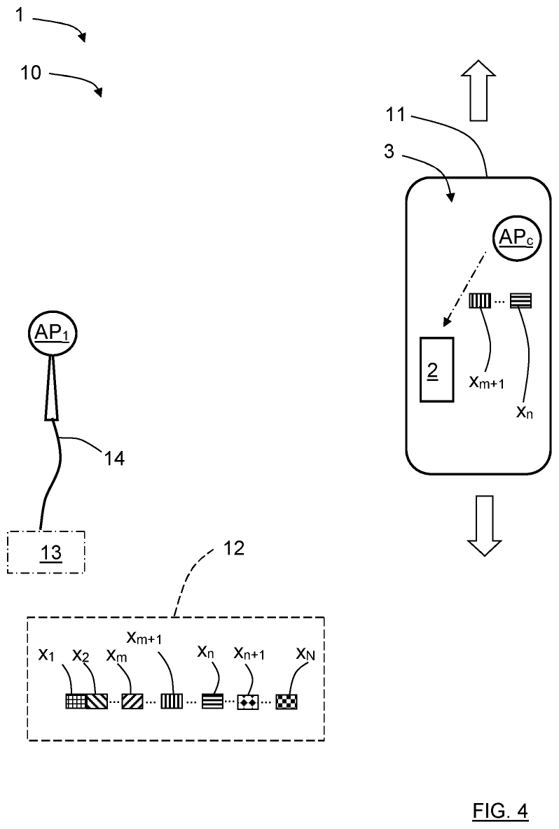

According to some aspects, in a fourth step, the user terminal 2 performs random access, and it gets connected to the cache node AP_{c}, finalizing the handover. Then, the cache node AP_{c} serves the user terminal 2 with its associated buffered predicted data xₘ₊₁ . . . xₙ as shown in FIG. 4.

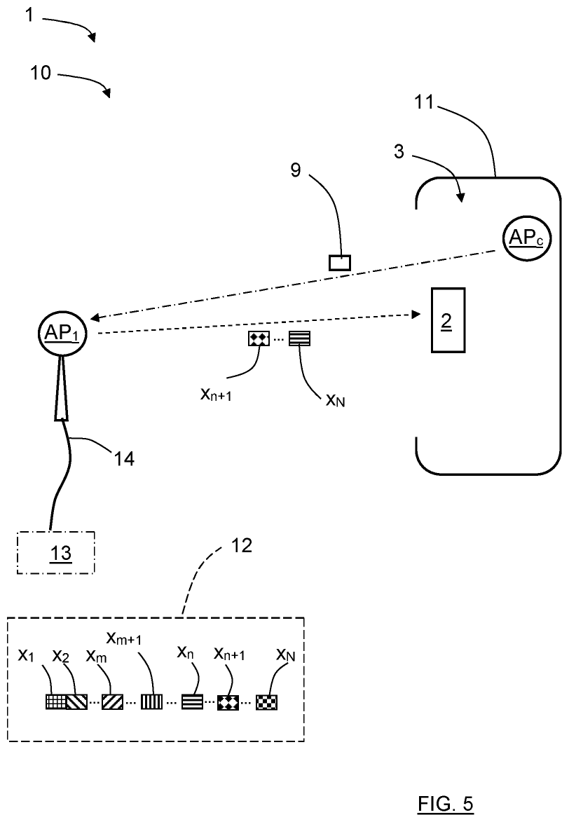

Finally, when the elevator 11 stops in a different floor as shown in FIG. 5, the door opens and both the user terminal 2 and the cache node AP_{c}, request access from the serving node AP₁. Then, being connected, the user terminal 2 receives the remaining part of its signal and the buffer of the cache node AP_{c} is filled in by the signals of new user terminals as well as the information about the associated user terminals.

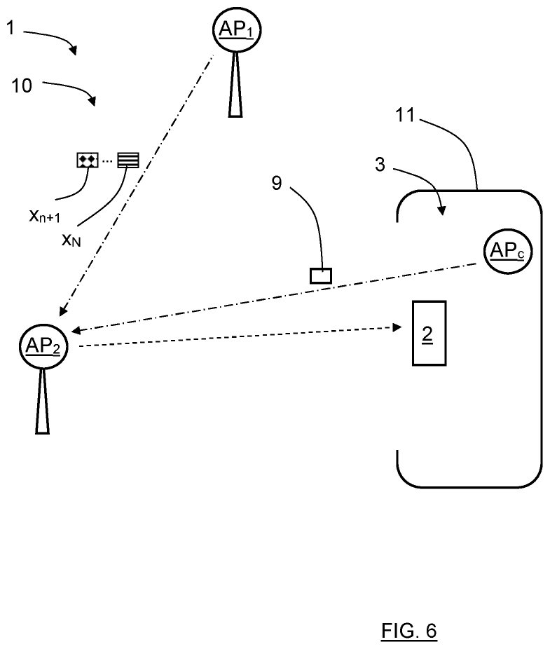

Alternatively, as shown in FIG. 6, when the elevator 11 stops in a different floor as shown in FIG. 5, the door opens and both the user terminal 2 and the cache node AP_{c}, request access from another serving node AP₂, here in the form of a second access point AP₂.

In any case, when the zone 3 becomes reachable for the serving node AP₁, AP₂, the serving node AP₁, AP₂ is adapted to receive information 9 from the cache node AP_{c} regarding which predicted data xₘ₊₁ . . . xₙ that has been transmitted to the user terminal 2 when the user terminal 2 has been unreachable for the serving node AP₁, AP₂ in the zone 3, and to perform handover for the user terminal 2, from the cache node AP_{c} to the serving node AP₁, AP₂.

According to some aspects, the serving node AP₁ is adapted to inform other nodes of an adapted scheduling, where the adapted scheduling is due to the fact that the cache node AP_{c} is prioritized while the zone is reachable and the serving node AP₁ performs handover to the cache node AP_{c} and transfers the predicted data xₘ₊₁ . . . xₙ to the cache node AP_{c}.

According to the present disclosure, a cache node is installed in the temporal dead zone, and a signaling procedure is adapted to serve user terminals when moving into the temporal dead zone. In order to maintain service continuity when a user terminal is moving into a dead zone such as an elevator, in accordance with some aspects, the following signaling should be adapted:
1) The user terminal 2 should be informed about the presence of the cache node AP_{c}, and be requested to do measurement/access to AP_{c}.
2) The cache node AP_{c} should receive the future signals of different user terminals, as well as their associated ID:s.
3) The AP:s in the IAB network should adapt their scheduling rules based on the priority of the cache node AP_{c}, and inform all other connected nodes correspondingly. In this way, the proposed scheme avoids dis-connectivity in temporal dead zones, improves the quality-of-service for the UEs and reduces the end-to-end transmission delay.

Finally, in view of the above, the following points should also be considered.

A setup has been presented for the cases with an AP inside the elevator 11. However, this is not necessary. The cache node inside the elevator 11 can also be considered as a UE-type of node. This is because there is no need to use high transmit power for delivering the cached video content to the user terminal being in the elevator 11, and there are normally not many user terminals to be served in the elevator 11. If the cache node is of a device/UE type, the main differences with the presented setup will be that the connection setup between the user terminal and the cache node AP_{c} will follow a sidelink connection setup procedure, and that the video delivering within the elevator 11 should be updated accordingly, as it will be done by using sidelink instead of downlink transmission.

There is some probability that a user terminal close to the elevator 11 does not move into the elevator 11 although the door is open. In such a case, there is no need for handover of the user terminal to the cache node AP_{c}. To guarantee service continuation in case the serving node AP₁ cannot detect if the user terminal will move into the elevator 11 or not, a soft handover procedure can be used where for a short period, where the user terminal is connected to both the serving node AP₁ and the cache node AP_{c}. Also, the user terminal's internal cache can help to guarantee continuous streaming in this case.

The cache node AP_{c} does not necessarily need to perform initial access every time it tries to connect to the serving node AP₁, because the cell-specific configuration of the serving node AP₁ can be rather fixed and the cache node AP_{c} can be configured such that it knows the system information about serving node AP₁ beforehand. As a result, the cache node AP_{c} only needs to perform a fast random access procedure to set up a connection to the serving node AP₁.

The cache node AP_{c} is responsible for serving a few user terminals during a relatively short period. Therefore, it does not need a large buffer, and can use uncomplicated methods to find out if the requested signals have been buffered.

The four steps above have been presented as an example. However, different orders of data transmission procedures can be considered as well. For instance, the cases where the serving node AP₁ sends the predicted data of interests of the user terminal to the cache node AP, were presented in the third step. However, the data can also be sent to the cache node AP, in the second step.

When the door is closed, the cache node AP, is not connected to the core network 13. Then, as the data and user terminal content information are already available at the cache node AP_{c}, the cache node AP, can act as an isolated edge node, and provide data communication to the user terminal within its coverage, e.g., inside the elevator 11.

The present disclosure can be implemented in both cases where the cache node AP, is capable of message encryption/decryption or it performs so-called blind caching over end-to-end encrypted signals. In case the cache node AP, can do encryption/decryption, the serving node AP₁ should provide the cache node AP, with the required encryption keys.

The above is applicable for all data types with predictable requests.

It is to be noted that according to some aspects, the cache node AP_{c} is adapted to inform the serving node AP₁ that it is a special node that is available only for a short period of time and should have priority compared to other nodes such as other access points.

The present disclosure relates to a smart data transmission technique for data transmission to user terminals in temporal dead zones. The objective is to guarantee continuous data transmission to the user terminals, or at least reduce the dis-connectivity period. For this purpose, an intermediate cache node is located in the temporal dead zones. Then, when the temporal dead zone is reachable, then an access point that is directly or indirectly connected to a core network fills in the buffer of the cache node by parts of the signals which may be requested by the user terminals when they move to the dead zones. Also, the signaling between different nodes and scheduling is adapted, and the user terminal can perform measurements and/or get connected to different nodes depending on their position.

In this way, the QoS experience of the user terminal is improved, the end-to-end data transmission delay is reduced, and continuous data transmission in temporal dead zones is made possible. Furthermore, end-to-end transmission delay of long files is reduced. This leads to better quality-of-service for the UEs as well as high end-to-end throughput. If a zone has a very poor signal-to-noise ratio (SNR) and is almost a dead zone, then the proposed scheme will offload the network since the AP:s in the IAB network do not have to allocate extensive resources to a link with very poor SNR. It also reduces the need for transport to multiple AP:s.

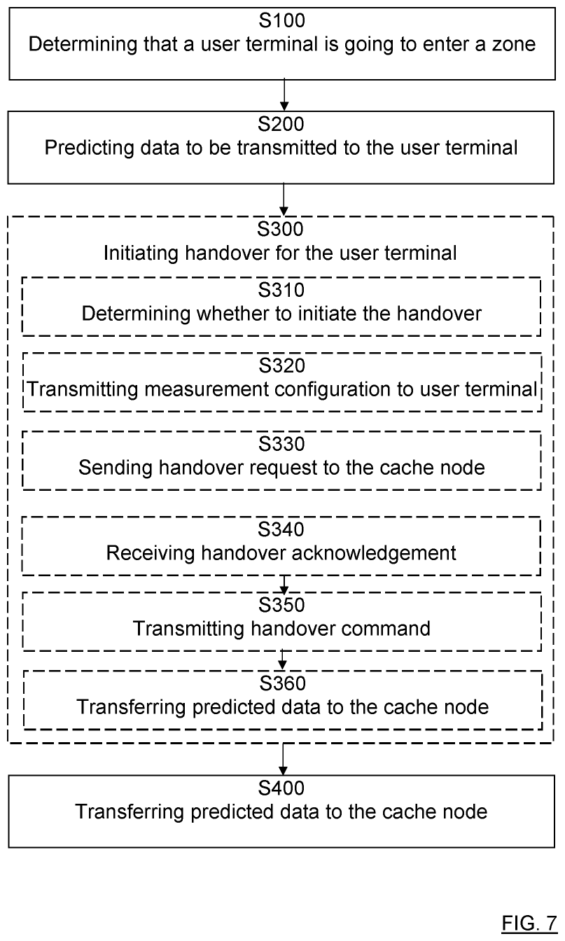

With reference to FIG. 7, the present disclosure relates to a method in a serving wireless communication node AP₁ in a wireless communication system 1, where the method comprises determining S100 that a user terminal is going to enter a zone 3 that switches between being reachable and unreachable for the serving node AP₁ and predicting S200 data to be transmitted to the user terminal 2 for at least a part of the time the user terminal 2 is unreachable in the zone 3. When the zone 3 is reachable, transferring S400 predicted data xₘ₊₁ . . . xₙ to a cache node AP_{c} positioned within the zone 3, enabling the cache node AP, to transfer the predicted data xₘ₊₁ . . . xₙ to the user terminal 2 when the user terminal 2 is in the zone 3 and is unreachable for the serving node AP₁.

According to some aspects, the method comprises initiating S300 a handover process for the user terminal 2, from the serving node AP₁ to the cache node AP_{c}.

According to some aspects, the initiating S300 comprises determining S310 whether to initiate the handover based on user terminal location information.

According to some aspects, the initiating S300 comprises transmitting a measurement configuration 4 to the user terminal 2, the measurement configuration 4 at least comprising information regarding which reference signal from the cache node AP, to measure and on which radio resources the measurement should be performed, enabling the user terminal 2 to transmit a measurement report 5 to the serving node AP₁, where the serving node AP₁ is adapted to determine whether to initiate the handover based on the measurement report 5.

According to some aspects, the initiating S300 comprises sending 330 a handover request 6 to the cache node AP_{c}, where the handover request 6 comprises information related to the user terminal 2.

According to some aspects, the information related to the user terminal 2 comprises at least one of user terminal identification, processor capability, and number of antenna ports.

According to some aspects, the initiating S300 comprises receiving 340 a handover acknowledgement 7 from the cache node AP_{c}, transmitting 350 a handover command 8 to the user terminal 2, and transferring 360 the predicted data xₘ₊₁ . . . xₙ to the cache node AP_{c}.

According to some aspects, the received handover acknowledgement comprises information related to the cache node AP_{c}.

According to some aspects, the information related to the cache node AP_{c} comprises at least one of cell identification and RACH configuration of the cache node AP_{c}.

According to some aspects, the method comprises informing other nodes of an adapted scheduling, where the adapted scheduling is due to the fact that the cache node AP_{c} is prioritized while the zone is reachable and the serving node AP₁ performs handover to the cache node AP_{c} and transfers the predicted data xₘ₊₁ . . . xₙ to the cache node AP_{c}.

According to some aspects, when the zone 3 becomes reachable for a serving node AP₁, AP₂, the method comprises receiving information 9 from the cache node AP_{c} regarding which predicted data xₘ₊₁ . . . xₙ that has been transmitted to the user terminal 2 when the user terminal 2 has been unreachable for the serving node AP₁, AP₂ in the zone 3, and to perform handover for the user terminal 2, from the cache node AP_{c} to the serving node AP₁, AP₂.

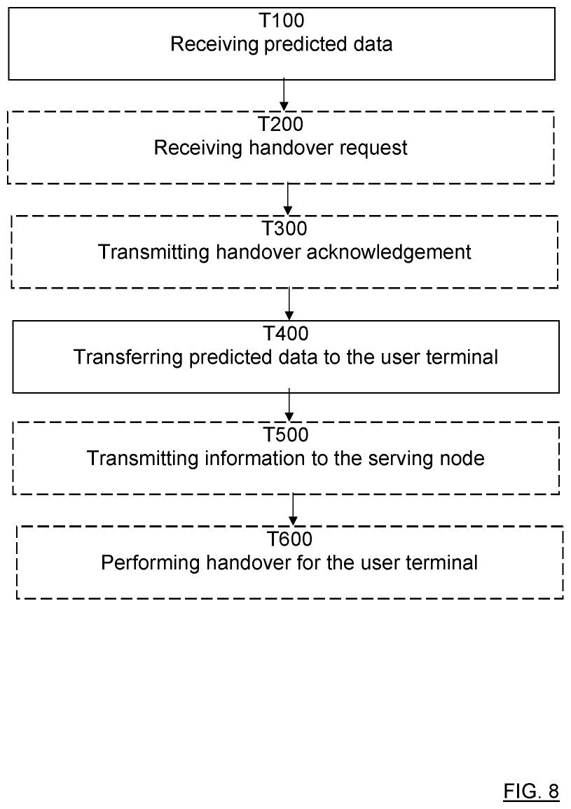

With reference to FIG. 8, the present disclosure also relates to a method in a cache node AP_{c} in a wireless communication system 1, where the cache node AP_{c} is positioned within a zone 3 that switches between being reachable and unreachable for a serving wireless communication node AP₁, wherein the method comprises receiving T100, from the serving node AP₁, predicted data xₘ₊₁ . . . xₙ to be transmitted to the user terminal 2 for at least a part of the time the user terminal 2 is unreachable for the serving node AP₁, and transferring T400 the predicted data xₘ₊₁ . . . xₙ to the user terminal 2 when the user terminal 2 is in the zone 3 and is unreachable for the serving node AP₁.

According to some aspects, the method comprises receiving T200 a handover request 6 from the serving node AP₁, where the handover request 6 comprises information related to the user terminal.

According to some aspects, the information related to the user terminal 2 comprises at least one of item identification, processor capability, and number of antenna ports.

According to some aspects, the method comprises transmitting T300 a handover acknowledgement 7 to the serving node AP₁, and to receive the predicted data xₘ₊₁ . . . xₙ from the serving node AP₁.

According to some aspects, the handover acknowledgement 7 comprises information related to the cache node AP_{c}.

According to some aspects, the information related to the cache node AP_{c} comprises at least one of cell identification and RACH configuration of the cache node AP_{c}.

According to some aspects, when the zone 3 becomes reachable for the serving node AP₁, the method comprises transmitting T500 information to the serving node AP₁, where the information relates to which predicted data that has been transmitted to the user terminal 2 when the user terminal 2 has been unreachable for the serving node AP₁ in the zone 3, and performing T600 handover for the user terminal 2, from the cache node AP_{c} to the serving node AP₁.

According to some aspects, the method comprises informing the serving node AP₁ about that the cache node AP_{c} is available only for a limited period of time and should be conferred priority compared to other nodes.

The present disclosure also relates to a wireless communication system 1 comprising an integrated access and backhaul, IAB, network 10 which in turn comprises at least the serving node AP₁ according to the above and the cache node AP_{c} according to the above.

The present disclosure also relates to a cache node AP_{c} in a wireless communication system 1, wherein the cache node AP_{c} is positioned within a zone 3 that switches between being reachable and unreachable for a serving wireless communication node AP₁, where the cache node AP_{c} is adapted to receive, from the serving node AP₁, predicted data xₘ₊₁ . . . xₙ to be transmitted to the user terminal 2 for at least a part of the time the user terminal 2 is unreachable for the serving node AP₁, and to transfer the predicted data xₘ₊₁ . . . xₙ to the user terminal 2 when the user terminal 2 is in the zone 3 and is unreachable for the serving node AP₁.

According to some aspects, the cache node AP_{c} is adapted to receive a handover request 6 from the serving node AP₁, where the handover request 6 comprises information related to the user terminal.

According to some aspects, the information related to the user terminal 2 comprises at least one of item identification, processor capability, antenna ports and latency.

According to some aspects, the cache node AP_{c} is adapted to transmit a handover acknowledgement 7 to the serving node AP₁, and to receive the predicted data xₘ₊₁ . . . xₙ from the serving node AP₁.

According to some aspects, the handover acknowledgement 7 comprises information related to the cache node AP_{c}.

According to some aspects, the information related to the cache node AP_{c} comprises at least one of cell identification and RACH configuration of the cache node AP_{c}.

According to some aspects, when the zone 3 becomes reachable for the serving node AP₁, the cache node AP_{c} is adapted to transmit information to the serving node AP₁, where the information relates to which predicted data that has been transmitted to the user terminal 2 when the user terminal 2 has been unreachable for the serving node AP₁ in the zone 3, and to perform handover for the user terminal 2, from the cache node AP_{c} to the serving node AP₁.

The present disclosure is not limited to the above, but may vary freely within the scope of the appended claims. For example, the present disclosure can be directed towards zones where the coverage needs to be boosted, where cache nodes can be provided adaptively by means of drones. A coverage may need to be boosted at a crowded place such as at a sport event, or for mission critical signaling such as for example military, police, ambulance and fire brigade actions. A mission critical video can be used by a first responder for his/her rescue mission when entering a temporarily dead zone that is out-of-network coverage, or a safety-monitory video used by a medical personnel in a hospital when he or she lost the network connection when entering an elevator, where a service disconnection can results in the loss of lives.

1. A serving wireless communication node in a wireless communication system, wherein the serving node is adapted to:
determine that a served user terminal is going to enter a zone that switches between being reachable and unreachable for the serving node;
predict data to be transmitted to the user terminal for at least a part of the time the user terminal is in the zone and is unreachable for the serving node; and
when the zone is reachable, transfer predicted data to a cache node positioned within the zone, enabling the cache node to transfer the predicted data to the user terminal when the user terminal is in the zone and is unreachable for the serving node.

2. The serving node according to claim 1, wherein
the serving node is adapted to initiate a handover for the user terminal, from the serving node to the cache node,
the serving node is adapted to determine whether to initiate a handover based on user terminal location information, and/or
the serving node is adapted to initiate a handover by sending a handover request to the cache node, further wherein the handover request comprises information related to the user terminal, and further wherein the information related to the user terminal comprises at least one of user terminal identification, processor capability, and number of antenna ports.

3. (canceled)

4. The serving node according to claim 2, wherein the serving node is adapted to transmit a measurement configuration to the user terminal, the measurement configuration at least comprising information regarding which reference signal from the cache node to measure and on which radio resources the measurement should be performed, enabling the user terminal to transmit a measurement report to the serving node, where the serving node is adapted to determine whether to initiate the handover based on the measurement report.

5-6. (canceled)

7. The serving node according to claim 2, wherein
the serving node is adapted to receive a handover acknowledgement from the cache node, to transmit a handover command to the user terminal, and then to transfer the predicted data to the cache node,
the received handover acknowledgement comprises information related to the cache node, and
the information related to the cache node comprises at least one of cell identification and RACH, Random Access Channel, configuration of the cache node.

8-9. (canceled)

10. The serving node according to claim 1, wherein the serving node is adapted to inform other nodes of an adapted scheduling, where the adapted scheduling is due to the fact that the cache node is prioritized while the zone is reachable and the serving node performs handover to the cache node and transfers the predicted data to the cache node.

11. The serving node according to claim 1, wherein, when the zone becomes reachable for a serving node the serving node is adapted to receive information from the cache node regarding which predicted data that has been transmitted to the user terminal when the user terminal has been unreachable for the serving node in the zone, and to perform handover for the user terminal, from the cache node to the serving node.

12. A cache node in a wireless communication system, wherein the cache node is positioned within a zone that switches between being reachable and unreachable for a serving wireless communication node, where the cache node is adapted to:
receive, from the serving node, predicted data to be transmitted to a user terminal for at least a part of the time the user terminal is unreachable for the serving node; and,
transfer the predicted data to the user terminal when the user terminal is in the zone and is unreachable for the serving node.

13. The cache node according to claim 12, wherein
the cache node is adapted to receive a handover request from the serving node, where the handover request comprises information related to the user terminal, and
the information related to the user terminal comprises at least one of item identification, processor capability, and number of antenna ports.

14. (canceled)

15. The cache node according to claim 13, wherein
the cache node is adapted to transmit a handover acknowledgement to the serving node, and to receive the predicted data from the serving node,
the handover acknowledgement comprises information related to the cache node, and
the information related to the cache node comprises at least one of cell identification and RACH, Random Access Channel, configuration of the cache node.

16-17. (canceled)

18. The cache node according to claim 12, wherein, when the zone becomes reachable for the serving node, the cache node is adapted to transmit information to the serving node, where the information relates to which predicted data that has been transmitted to the user terminal when the user terminal has been unreachable for the serving node in the zone, and to perform handover for the user terminal, from the cache node to the serving node.

19. A method in a serving wireless communication node in a wireless communication system, wherein the method comprises:
determining that a user terminal is going to enter a zone that switches between being reachable and unreachable for the serving node;
predicting data to be transmitted to the user terminal for at least a part of the time the user terminal is unreachable in the zone;
when the zone is reachable, transferring predicted data to a cache node positioned within the zone, enabling the cache node to transfer the predicted data to the user terminal when the user terminal is in the zone and is unreachable for the serving node.

20. The method according to claim 19, wherein
(i) the method comprises initiating a handover process for the user terminal, from the serving node to the cache node,
(ii) the method comprises determining whether to initiate a handover based on user terminal location information, and/or
(iii) the method comprises initiating a handover process by sending a handover request to the cache node, further wherein the handover request comprises information related to the user terminal and further wherein the information related to the user terminal comprises at least one of user terminal identification, processor capability, and number of antenna ports.

21. (canceled)

22. The method according to claim 20, wherein the initiating comprises transmitting a measurement configuration to the user terminal, the measurement configuration at least comprising information regarding which reference signal from the cache node to measure and on which radio resources the measurement should be performed, enabling the user terminal to transmit a measurement report to the serving node, where the serving node is adapted to determine whether to initiate the handover based on the measurement report.

23-24. (canceled)

25. The method according to claim 22, wherein the initiating comprises:
receiving a handover acknowledgement from the cache node,
transmitting a handover command to the user terminal, and
transferring the predicted data to the cache node, wherein
the received handover acknowledgement comprises information related to the cache node, and
the information related to the cache node comprises at least one of cell identification and RACH, Random Access Channel, configuration of the cache node.

26-27. (canceled)

28. The method according to claim 19, wherein the method comprises informing other nodes of an adapted scheduling, where the adapted scheduling is due to the fact that the cache node is prioritized while the zone is reachable and the serving node performs handover to the cache node and transfers the predicted data to the cache node.

29. The method according to claim 19, wherein, when the zone becomes reachable for a serving node, the method comprises receiving information from the cache node regarding which predicted data that has been transmitted to the user terminal when the user terminal has been unreachable for the serving node in the zone, and to perform handover for the user terminal, from the cache node to the serving node.

30. A method in a cache node in a wireless communication system, where the cache node is positioned within a zone that switches between being reachable and unreachable for a serving wireless communication node, wherein the method comprises:
receiving, from the serving node, predicted data to be transmitted to a user terminal for at least a part of the time the user terminal is unreachable for the serving node, and
transferring the predicted data to the user terminal when the user terminal is in the zone and is unreachable for the serving node.

31. The method according to claim 30, wherein
the method comprises receiving a handover request from the serving node, where the handover request comprises information related to the user terminal, and
the information related to the user terminal comprises at least one of item identification, processor capability, and number of antenna ports.

32. (canceled)

33. The method according to claim 31, wherein
the method comprises transmitting a handover acknowledgement to the serving node, and to receive the predicted data from the serving node,
the handover acknowledgement comprises information related to the cache node, and
the information related to the cache node comprises at least one of cell identification and RACH, Random Access Channel, configuration of the cache node.

34-35. (canceled)

36. The method according to claim 30, wherein,
(i) when the zone becomes reachable for the serving node, the method comprises:
transmitting information to the serving node, where the information relates to which predicted data that has been transmitted to the user terminal when the user terminal has been unreachable for the serving node in the zone, and
performing handover for the user terminal, from the cache node to the serving node, and/or
(ii) the method comprises informing the serving node about that the cache node is available only for a limited period of time and should be conferred priority compared to other nodes.

37-38. (canceled)
